(19) United States
(12) Patent Application Publication
(10) Pub. No.: US 2026/0119967 A1
(43) Pub. Date: Apr. 30, 2026

(54) PAIRED TUNING OF GENERATIVE MODELS

(71) Applicant: International Business Machines Corporation, Armonk, NY (US)

(72) Inventors: Jarret Ross, Wichita, KS (US); Brian Michael Belgodere, Fairfield, CT (US); Payel Das, YORKTOWN HEIGHTS, NY (US); Enara C. Vijil, Westchester, NY (US); Samuel Chung Hoffman, New York, NY (US); Youssef Mroueh, New York, NY (US)

(73) Assignee: International Business Machines Corporation, Armonk, NY (US)

(21) Appl. No.: 18/925,963

(22) Filed: Oct. 24, 2024

(51) Int. Cl. G06N 20/00

(52) U.S. Cl. CPC G06N 20/00

(57) ABSTRACT

A set of enhancement tokens is configured to correspond to a property “p”. A training input is constructed for a pre-trained decoder-only generative model (model), the training input including the set of enhancement tokens, a set of first molecular description tokens representing an initial molecule, and a set of second molecular description tokens representing a target molecule. The property “p” in the target molecule is better relative to property “p” in the initial molecule. The model is executed with the training input and a vector of adjusted enhancement tokens (enhancement vector) is generated from the model, the enhancement vector corresponding to an improvement in property “p”.

### BACKGROUND

The present invention relates generally to the field of artificial intelligence using generative models such as Large Language Models, automatic machine learning, and data science. More particularly, the present invention relates to a method, system, and computer program for paired tuning of generative models.

Artificial intelligence (AI) technology has evolved significantly over the past few years. Modern AI systems are achieving human-level performance on cognitive tasks like converting speech to text, recognizing objects and images, and translating between different languages. This evolution holds promise for new and improved applications in many industries.

A Large Language Model (LLM, plural LLMs) is a type of software designed to understand and generate human-like text. LLMs are trained on massive amounts of data from books, articles, websites, and other written sources. At their core, LLMs use a neural network in a transformer architecture that has layers of interconnected nodes that process and interpret text data. An Artificial Neural Network (ANN) is a computing system made up of a number of simple, highly interconnected processing elements, which process information by their dynamic state response to external inputs. ANNs are processing devices (algorithms and/or hardware) that are loosely modeled after the neuronal structure of the mammalian cerebral cortex but on smaller scales. A large ANN implementation of an LLM might have tens of millions of interconnected nodes. By comparison, a mammalian brain has billions of neurons with a corresponding increase in the magnitude of their overall interaction and emergent behavior.

Conventional AI techniques use large data sets to train LLMs and use the trained LLM to identify patterns and draw conclusions in response to inputs. For example, LLMs can analyze the context of the words in a sentence or passage by looking at how words relate to each other in terms of meaning and usage and generate relevant and coherent responses.

AI systems also use LLMs as predictive models to perform these functions under different or changing conditions. When given a prompt or question, a model predicts what comes next based on the patterns learned during training. This prediction is generally made word by word, generating responses that aim to be contextually appropriate and informative. After the initial training, LLMs can be fine-tuned on specific types of text or for particular tasks to improve their performance in those areas. LLMs are designed to mimic human language abilities for tasks like answering questions, writing content, or translating languages.

The quality of an output of an LLM is highly dependent on the training of that LLM. Particularly, the quality of the data used to train an LLM can directly impact the quality—in terms of accuracy, applicability, currency, contextual appropriateness—of the output.

Trained models are increasingly being used in molecular research, such as to find compound molecules that exhibit a set of desired properties. Molecular optimization is the practice of making changes to known, initial molecules with the goal of improving various characteristics. Molecular optimization in the context of model training refers to the use of computational models, often involving machine learning, to improve or design molecules with desired properties. Model training for molecular optimization is common in areas like drug discovery, material science, and chemistry, where the goal is to optimize molecular structures to enhance specific characteristics such as biological activity, stability, solubility, or binding affinity.

Large amounts of data are collected on molecular structures and their properties and large databases exist for unsupervised learning. Molecules are represented in forms that can be processed by the model, such as SMILES (Simplified Molecular Input Line Entry System) strings or molecular graphs. Relevant features are extracted from the molecular representations, such as atom types, bond types, molecular weight, electronegativity, and other chemical properties.

Presently, a machine learning model is trained on the dataset to predict the properties or behavior of molecules. Models like deep neural networks (DNNs), random forests, or graph neural networks (GNNs) are often used in this manner because these models can capture the complex relationships between molecular structure and properties. Once a model is trained, optimization algorithms are applied to explore the molecular space. Algorithms such as reinforcement learning (RL), genetic algorithms (GA), or Bayesian optimization are used to iteratively adjust the molecular structures to achieve the desired properties. The generated molecules are evaluated using the trained model, and the most promising candidates are further validated with experimental or high-accuracy computational methods like density functional theory (DFT).

Finding molecules with high binding affinity to target proteins is important in fields like drug discovery. Molecular optimization is useful in material science for designing materials with optimal thermal, electrical, or mechanical properties. The field of chemical engineering uses molecular optimization for optimizing catalysts or other functional chemicals.

The illustrative embodiments recognize that presently used translation-based approaches attempt to use pairs of training molecules to learn a sequence-to-sequence mapping to directly generate an improved molecule. However, the illustrative embodiments recognize that these approaches require learning of translator model per task, which is computationally expensive. Furthermore, current generative models using these approaches cannot effectively find molecules in their latent spaces that have desired properties. The illustrative embodiments further recognize that another type of presently used approach—rationale-based approaches—build molecules from key substructures and are not suitable for the de novo discovery of property-enhanced molecules. The illustrative embodiments also recognize that presently available reinforcement learning-based approaches are also unsuitable for molecular optimization-type tasks because those approaches need multiple calls to a reward model, which can be computationally expensive.

The illustrative embodiments described herein propose to improve a decoder-only model for molecular optimization and other fields where decoder-only models are routinely used, such as in natural language processing (NLP) for text generation, summarization, translation, or dialogue systems. A decoder-only model is a type of neural network architecture that focuses on the decoder component of the Transformer architecture. A decoder-only model uses the decoder stack from the Transformer architecture, without the encoder part. The decoder in the Transformer architecture consists of multiple layers of self-attention mechanisms and feed-forward networks. These components allow the model to understand and generate sequences of text. In a decoder-only model, causal masking (also called autoregressive masking) is applied to ensure that, when predicting the next token in a sequence, the model can only attend to the tokens that came before it in the sequence, thus preventing the model from “seeing” future tokens during training and ensures predictions are made one token at a time, as in an autoregressive manner. Unlike encoder-decoder models, decoder-only models do not require a separate input and output structure. The input to a decoder-only model is simply the sequence of tokens, and it generates outputs one token at a time.

Prompt tuning for a decoder-only model is a technique that involves modifying or crafting the input prompt in a way that guides the model toward generating more specific or desired outputs. Prompt tuning is an efficient way to adapt large pre-trained models like GPT (a classic decoder-only model) to specific tasks without needing to fine-tune the entire model. Instead, small adjustments or learned prompts are introduced to steer the model's behavior.

Rather than manually crafting prompts, prompt tuning automates and learns the prompt that works best for a given task. This approach fine-tunes the model by learning specific prompt embeddings that help the model perform better on a downstream task. A small set of learnable embeddings (often called “soft prompts”) is prepended to the input sequence. These learned embeddings act like the context that helps condition the model for a particular task or dataset.

These embeddings are typically optimized during training on specific tasks, much like how traditional models are trained. However, the model's weights remain frozen, and only the prompt embeddings are adjusted. This makes prompt tuning computationally lightweight compared to full fine-tuning.

Where fine-tuning involves updating the entire model's weights to improve performance on a particular task-a process that requires significant computational resources and large datasets, prompt tuning only tunes the prompt embeddings, leaving the model's parameters unchanged. Prompt tuning is a more efficient approach than fine-tuning when a large, pre-trained model is already available because only a small number of parameters (the prompts) are fine-tuned in the otherwise pre-trained model.

### SUMMARY

The illustrative embodiments provide for paired tuning of generative models. An embodiment includes configuring a set of enhancement tokens to correspond to a property p. the embodiment includes constructing a training input to a pre-trained decoder-only generative model (model), the training input comprising the set of enhancement tokens, a set of first molecular description tokens representing an initial molecule, and a set of second molecular description tokens representing a target molecule, wherein property p in the target molecule is better relative to property p in the initial molecule. The embodiment includes executing the model with the training input. The embodiment includes generating from the model, responsive to the executing, a vector of adjusted enhancement tokens (enhancement vector), the enhancement vector corresponding to an improvement in property p.

Other embodiments of this aspect include corresponding computer systems, apparatus, and computer programs recorded on one or more computer storage devices, each configured to perform the actions of the embodiment.

An embodiment includes a computer-usable program product. The computer-usable program product includes a computer-readable storage medium and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of a configuration for paired tuning of generative models in accordance with an illustrative embodiment;

FIG. 3 depicts a block diagram of an operation of an improved model in accordance with an illustrative embodiment;

FIG. 4 depicts a flowchart of an example process for paired tuning of generative models in accordance with an illustrative embodiment; and

FIG. 5 depicts a flowchart of an example process for generating molecular sequences with one or more improved properties in accordance with an illustrative embodiment.

### DETAILED DESCRIPTION

In one embodiment for training the pair tuning for enhancing property p, a set of enhancement tokens is configured to correspond to an improvement in property p, a training input is constructed for a pre-trained decoder-only generative model (model), the training input including the set of enhancement tokens, a set of first molecular description tokens representing an initial molecule, and a set of second molecular description tokens representing a target molecule, where property p in the target molecule is better relative to property p in the initial molecule, and the model is executed with the training input. From the model, in response to the executing, a vector (or a matrix) of adjusted enhancement tokens (enhancement vector) is generated, the enhancement vector corresponding to an improvement in property p. Thus, the embodiment provides an efficient method for searching the molecular search space for molecules that trend in a desirable direction of a certain property.

Another embodiment further updates by virtue of training, as a part of the executing, during a first iteration of execution, an enhancement token in the set of enhancement tokens, the update forming a second set of enhancement tokens. The embodiment constructs a second training input using the updated set of enhancement tokens. The embodiment executes the model in a second iteration of execution with the second training input. Thus, the embodiment provides an iterative manner of constructing the enhancement vector until a certain point such that the enhancement vector is capable of causing the model to produce molecular sequences that show desirable trend in certain molecular properties.

Another embodiment further forms a plurality of enhancement vectors corresponding to a plurality of properties. The embodiment interpolates, from the plurality of enhancement vectors, an interpolated enhancement vector, where the interpolated enhancement vector corresponds to the plurality of properties. The embodiment constructs a new input to a pre-trained decoder-only generative model configured for molecule optimization (optimization model), the new input comprising the interpolated enhancement vector and a set of new molecular description tokens, the set of new molecular description tokens corresponding to a new molecule. The embodiment executes the optimization model with the new input. The embodiment outputs, responsive to the interpolated enhancement vector, from the optimization model, an improved new molecular sequence, where the improved new molecular sequence comprises an improvement in a first property in the plurality of properties in a new molecule corresponding to the new molecular sequence. Thus, the embodiment provides an efficient method for simultaneously searching the molecular search space for molecules with multiple properties that trend in a desirable direction of at least one property.

In another embodiment, the improved new molecular sequence further includes an improvement in a second property in the plurality of properties in the new molecule corresponding to the new molecular sequence. Thus, the embodiment provides an efficient method for searching the molecular search space for molecules that trend in a desirable direction of a set of properties.

In another embodiment, the model is the optimization model. Thus, the embodiment provides a manner of training the enhancement vectors and then using the enhancement vectors using the same or similar models.

In another embodiment, the model is distinct from the optimization model. Thus, the embodiment provides a manner of training the enhancement vectors with one instance of the model and then using the enhancement vectors in a different instance of the same model, without having to switch the same instance of the model over from a training mode at training time to an inference mode at inference time.

Another embodiment stops the executing after a preset number of iterations, where an iteration of execution modifies at least one enhancement token in the set of enhancement tokens. Thus, the embodiment provides a manner of constructing the enhancement vector in a finite time and number of training operations with a model.

Another embodiment constructs a second training input comprising a second set of enhancement tokens, the set of first molecular description tokens representing the initial molecule, and the set of second molecular description tokens representing the target molecule, wherein property q in the target molecule is better relative to property q in the initial molecule. The embodiment executes the model with the second training input and generates from the model a second vector of adjusted enhancement tokens (second enhancement vector), the enhancement vector corresponding to an improvement in property q. Thus, the embodiment provides a method for modifying different properties by constructing different enhancement vectors using the same initial and target molecular sequences.

In another embodiment, property p includes a first aspect and a second aspect, the improvement in property p is an improvement in the first aspect of property p, and the enhancement vector corresponds to the improvement in the first aspect of property p. The embodiment further constructs a second training input including a second set of enhancement tokens, the set of first molecular description tokens representing the initial molecule, and the set of second molecular description tokens representing the target molecule, where the second aspect of property p in the target molecule is better relative to the second aspect of property p in the initial molecule. The embodiment executes the model with the second training input and generates from the model a second vector of adjusted enhancement tokens (second enhancement vector), the second enhancement vector corresponding to an improvement in the second aspect of property p. Thus, the embodiment provides a way for enhancing different aspects of the same property in molecular sequences.

Another embodiment pre-trains a decoder-only generative model with training data. The embodiment freezes after the pre-training, the set of pre-training weights in the decoder-only generative model to form the pre-trained decoder-only generative model. Thus, the embodiment provides another step in the novel way of efficiently training a pre-trained model for searching molecular search space for sequences with desirable property enhancements.

Identifying molecules with desirable properties from the vast landscape of possibilities is daunting. It has been postulated that only 10⁸ out of 10²³-10⁶⁰ possible small drug-like molecules are synthesizable. The illustrative embodiments recognize that the search space for molecules with optimal properties is enormous, and high-throughput screening of molecules is costly and time-consuming and requires a thorough understanding of the chemical data manifold.

To help address these and similar problems, the illustrative embodiments provide paired tuning of generative models. The illustrative embodiments describe method for creating and using improved deep generative model for modeling molecular distributions and sampling new molecules from the distribution.

The illustrative embodiments recognize that a novel manner of prompt tuning called “paired tuning,” as described herein, when applied to a pre-trained decoder-only generative model can significantly improve the model's performance in property optimization tasks. Paired tuning is an improved prompt-tuning or soft prompt-learning methodology that causes a pre-trained decoder-only generative model to learn from partial orderings of pairs of input tokens. Paired tuning is described herein with respect to the field of molecular optimization, but is similarly applicable to—and adaptable in—many other fields where decoder-only models are used, such as NLP, and such adaptations to fields other than molecular optimization are contemplated within the scope of the illustrative embodiments. Hereinafter, a reference to a model is a reference to a pre-trained decoder-only generative model (pre-trained decoder-only generative model) unless the term is expressly distinguished where used. Hereinafter, a reference to an improved model is a reference to a pre-trained decoder-only generative model as improved in accordance with one or more embodiments described herein unless the term is expressly distinguished where used.

A decoder-only generative model is pre-trained using unsupervised training on molecular string representations data. As described herein, ZINC and PubChem are some examples of large training datasets of this nature—including chemical string representation data—that can be used in this training to form a pre-trained decoder-only generative model.

In one embodiment, a pre-trained decoder-only generative model is supplied with training data that is constructed to cause paired tuning (“paired-tuning input”). Specifically, the paired-training input is constructed in such a way that the input includes one or more pairs of tokenized molecules description sequences where the second molecule description sequence in a pair is more desirable than the first molecule description sequence in the pair.

An input token in a paired-training input, where the token is representative of all or a portion of a molecular sequence representation according to SMILES or any other convention, is hereinafter referred to as a molecule description token (or, molecular description token). The desirability of the second tokenized molecule description sequence over the first tokenized molecule description sequence is presumably for some enhancement of some property of the molecule. However, advantageously, according to the illustrative embodiments, the specific property, the specific enhancement, and the degree of the specific enhancement need not be specified in the input training data. A property of the second tokenized molecule description sequence is simply better, improved, or more desirable than the same property of the first tokenized molecule description sequence to some degree, measurement, or preference.

The input representation chosen for the clarity of the description, and without implying a limitation thereto, is chemical SMILES. A paired-training input according to an embodiment is constructed as a token embedding modulated with relative positional embedding, e.g., rotary positional embedding, to model the token dependency within SMILES. During training using a paired-training input, a pre-trained decoder-only generative model uses a causal modeling objective of predicting the next token given the context history of prior tokens in the paired-training input.

Furthermore, when more than one pair is specified in the training data input, the only constraint is that within each pair, one tokenized sequence is better than the other tokenized sequence in the pair for some property of the molecule that is represented by the sequences. Again, exact property identification or enhancement scores are not needed in the input. Similarly, no separate property predictor or reward model is needed in the paired tuning method. In one example implementation, a single forward pass with a paired-training input was completed in only approximately 3 milliseconds using a single A100 GPU.

Some examples of molecular description tokens include, but are not limited to C (a Carbon atom), = (a double bond), n (aromatic nitrogen), Na+ (Sodium ion), and so on. A number of enhancement tokens are also prefixed in a paired-training input. An enhancement token (represented herein as <enh₁>, <enhₙ> etc.) identifies to the pre-trained decoder-only generative model a set of adjustment tokens that are usable to achieve the property improvement represented by the paired training input. Additionally, the paired-training input also includes some marker tokens to mark the beginning of the input, end of input, transition within the input, and other such organizational and structural markings within the paired-training input. Some examples of such marker tokens include, but are not limited to—bos (beginning of sequence, represented herein as <bos>), cos (end of sequence, represented herein as <cos>), sep (separator, represented herein as <sep>), etc.

In the training phase, an embodiment starts with a set (or a vector) of enhancement tokens and produces a set (or a vector) of modified or adjusted enhancement tokens. In the optimization phase, an embodiment constructs a model input using the vector of adjusted enhancement tokens with a tokenized molecule sequence. The input in the optimization phase causes the model to produce a molecule sequence that has a property improvement relative to the molecule sequence of the input.

In the training phase, using a pre-trained decoder-only generative model, an embodiment defines—
a number of iterations or epochs to execute, m;
a number of enhancement tokens in the vector, n; and
a paired-tuning dataset D, where D={(a,b), b>a} for a,bϵΩ where > is an order relation defined for a certain property p.

The embodiment appends n enhancement tokens <enh₁><enh₂> . . . <enhₙ> (i.e., an enhancement vector) and a <sep> token to the vocabulary.

$${φ}_{T} = 〈 {enh}_{1} 〉 〈 {enh}_{2} 〉 … 〈 {enh}_{n} 〉 , 〈 sep 〉$$

The embodiment iterates for m iterations as follows—
1. Prepare training prompt (paired-training input) as

$$〈 {enh}_{1} 〉 〈 {enh}_{2} 〉 … 〈 {enh}_{n} 〉 〈 bos 〉 〈 {a}_{1} 〉 〈 {a}_{2} 〉 … 〈 {a}_{i} 〉 〈 sep 〉 〈 {b}_{1} 〉 〈 {b}_{2} 〉 … 〈 {b}_{n} 〉 〈 eos 〉$$

where a=<a₁><a₂> . . . <aᵢ>, is a tokenized training molecule, <a₁><a₂>> . . . <aᵢ> are each an molecular description token, <a₁> . . . <aᵢ> is the first member of a pair.
2. Compute the cross-entropy (CE) loss conditioned on enhancement tokens φ_{T} and molecule a with the auto-regressive CE loss with target molecule b=<b₁><b₂> . . . <bₙ><eos>
   where b=<b₁><b₂>> . . . <bₙ>, is the second member of the pair and has the improved property relative to the first member of the pair.
3. Compute the gradient of the auto-regressive CE loss with respect to enhancement tokens φ_{T}
4. Update enhancement tokens via gradient descent optimizer until m epochs have elapsed.

At the end of m epochs, the embodiment produces a vector of adjusted enhancement tokens. One vector of adjusted enhancement tokens corresponds to one property and improves that one property in one manner. Different vectors of adjusted enhancement tokens can be similarly created using the illustrative embodiments for improving different properties, improving different aspects of the same property if the property has multiple improvable aspects, or some combination thereof.

According to the illustrative embodiments, at runtime—or inference time—during the optimization phase, a matrix of adjusted enhancement tokens that was produced in a training phase is usable for producing a target molecule sequence d from a source molecule sequence c where a property of molecule d is improved relative to the same property in molecule c.

Thus, the embodiment provide an improvement over prompt-tuning or “soft prompt” learning, by (i) including in the paired-training input ordered and paired tokenized molecular sequences {(a,b)|b>a}, and (ii) including in the paired-training input an additional n tunable tokens for each downstream task, which are prepended to the ordered and paired molecular sequences. This paired-training input is then used to train the enhancement tokens using a pre-trained decoder-only generative model end-to-end on a labeled dataset, while keeping the pre-trained decoder-only generative model's pre-trained weights frozen.

The task of generating a (property-) optimal molecule using an embodiment can be summarized as follows: Given a molecule a, translate it to another molecule b with a more optimal property value where a,b come from domain Ω. This conditional generation task is P_{θ}(b|a), where θ is the parametrization of the generative language model. This task is handled via learning soft prompts, i.e., prompt-tuning, which is a parameter-efficient task adaptation method for a frozen language model. Specifically, the embodiment adds a relatively small number of task-specific parameters φ_{T}, such that the conditional task becomes P_{θ}(b|φ_{T}, a) and is trained through maximizing the probability likelihood of b. Only φ_{T} is updated during gradient backpropagation.

An entire vector of enhancement tokens corresponds to a property. An entire vector of adjusted enhancement vectors corresponds to an improvement in a property. In an embodiment, the training process is repeated with different paired-training inputs using different vectors of <enh₁> . . . <enhₚ> enhancement tokens to produce different vectors of adjusted enhancement tokens. A vector of adjusted enhancement tokens produced in this manner at training time is then used at optimization time with a previously unseen molecule sequence. Using the vector of adjusted enhancement tokens and the tokenized unseen molecular sequence, the model produces a new molecular sequence in which a property corresponding to the vector of adjusted enhancement tokens has been improved relative to the same property in the unseen molecule.

The enhancement vectors, i.e., the vectors of adjusted enhancement tokens, are learnt for each property in a set of properties at the end of the prescribed epochs for each property. Multiple enhancement vectors can be combined to cause a model to apply multiple property enhancements to an unseen molecule and produce a target molecule having those multiple property enhancements. In order to apply multiple property enhancements in this manner, another embodiment computes a weighted average of the set of enhancement vectors corresponding to a set of properties—

$$〈 {enh}_{i}^{pq} 〉 = α 〈 {enh}_{i}^{p} 〉 + ( 1 - α ) 〈 {enh}_{i}^{q} 〉 , ∀ i ϵ 1 … n ,$$

where <enhᵢ^{p}> is an enhancement vector corresponding to property p,
<enhᵢ^{q}> is an enhancement vector corresponding to property q,
<enhᵢ^{pq}> is a combined enhancement vector corresponding to properties p and q,
and α and (1−α) are weighting factors for the depicted example of two enhancement vectors corresponding to the two properties p and q. In case of t enhancement vectors corresponding to t properties, other weighting factors totaling to a total weight of 1, can be used in a similar manner, within the scope of the illustrative embodiments.

The embodiment constructs an interpolated enhancement vector using one or more weighted interpolated enhancement tokens obtained in this manner, e.g. —

$$〈 {enh}_{1}^{pq…t} 〉 〈 {enh}_{2}^{pq…t} 〉 〈 {enh}_{x}^{pq…t} 〉 〈 bos 〉 〈 {c}_{1} 〉 〈 {c}_{2} 〉 … 〈 {c}_{n} 〉 〈 sep 〉$$

As shown in this example, the embodiment uses the interpolated enhancement vector in a model. The embodiment causes the model to generate a molecule sequence d from a molecule sequence c at runtime, where molecule d has multiple properties p, q . . . t, simultaneously improved relative to molecule c.

Operating in this manner, the illustrative embodiments do not need absolute property values of the molecules, but only ordered pairs of molecules and one or more enhancement vectors. This manner of operation mimics the scenario of many drug and material development tasks, in which two molecules are compared with each other to guide molecular optimization and prioritization, especially for tasks with limited available data. For example, Matched Molecular Pair (MMP) analysis allows the rapid estimation of property differences. However, MMP analysis is limited to comparing close molecular derivatives and common molecular derivations, and it can fail to model important chemical contexts. The method of optimizing molecules using the illustrative embodiments is free from such constraints and only aims to learn task-specific soft prompts to generate more optimal molecules given a seed molecule.

Some advantages derivable from an improved model include, but are not limited to—better validity, diversity, etc. of property-optimized molecules; lightweight soft-prompt learning procedure that is applicable to pre-trained decoder-style models; multiple properties can be easily optimized using a linear combination of individual property enhancement improved models; just relatively ranked training pairs are needed to produce property-enhanced molecules from an improved model without needing any surrogate or auxiliary reward model.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting on the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

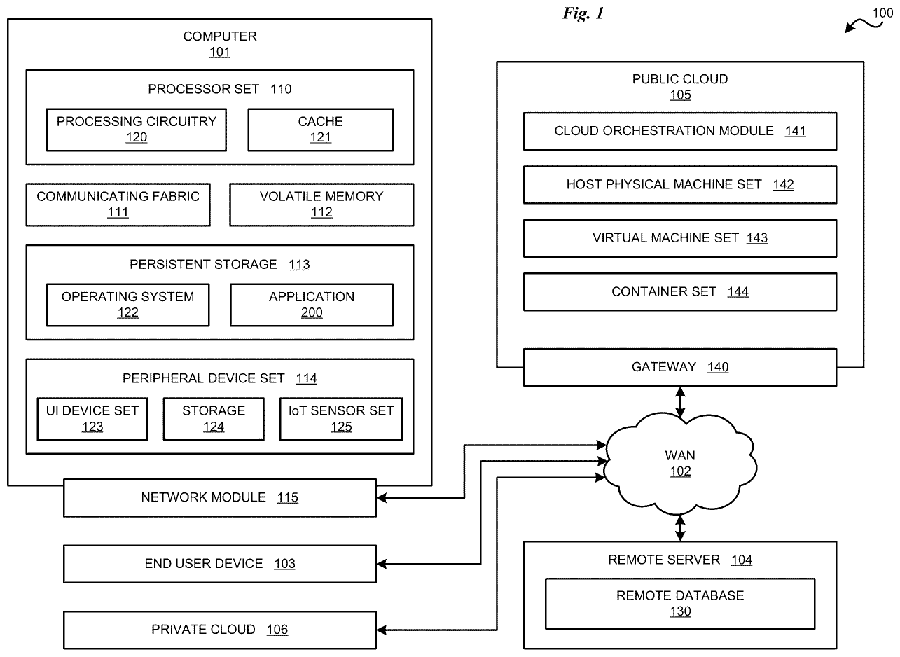

With reference to FIG. 1, this figure depicts a block diagram of a computing environment 100. Computing environment 100 contains an example of an environment for the execution of at least some of the computer code involved in performing the inventive methods, such as application 200 that may execute in computing environment 100 and implement one or more embodiments for paired tuning of generative models as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

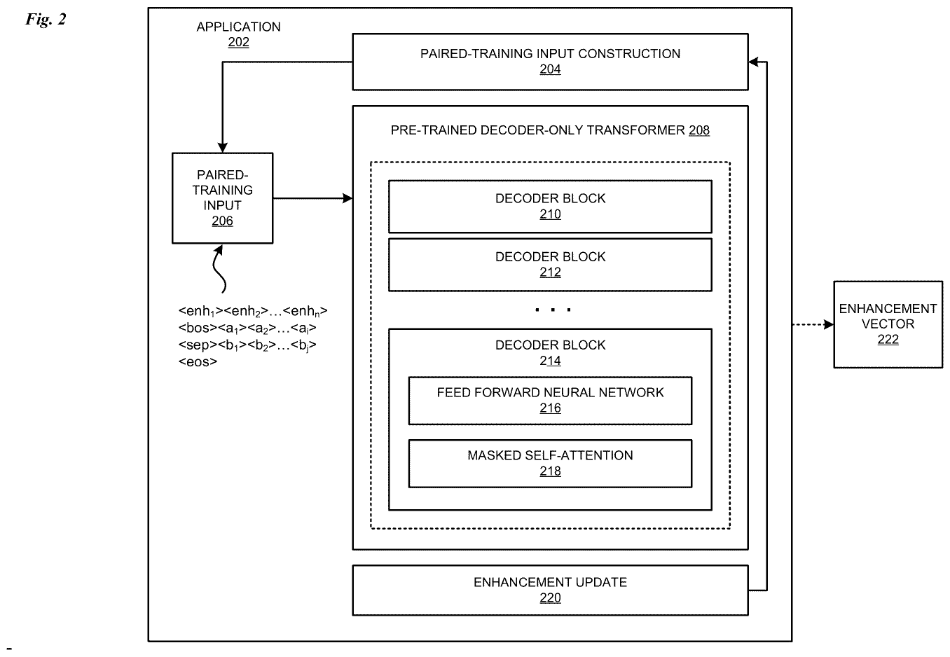

With reference to FIG. 2, this figure depicts a block diagram of a configuration for paired tuning of generative models in accordance with an illustrative embodiment. Application 202 can be implemented as application 200 in FIG. 1.

Application 202 includes component 204, which constructs a paired-training input as described herein. Paired-training input 206 is an example of a paired-training input constructed from component 204.

This figure and the corresponding description describe a training mode of operation in which a vector of adjusted enhancement tokens is created as described herein. The application inputs paired-training input 206 into a pre-trained model, such as model 208. In the depiction, application 202 is depicted as a wrapper around model 208 only as a non-limiting example. Model 208 can be operated outside of application 202, to wit, application 202 can operate in conjunction with model 208 operating anywhere in a data processing environment.

As described herein, model 208 is a pre-trained decoder-only generative model and includes a number of decoder blocks 210, 212 . . . 214. A decoder block in model 208, e.g., decoder block 214 includes feed-forward neural network 216 and masked self-attention block 218.

Pre-trained decoder-only generative model 208 iteratively operates on paired-training input 206 for a specified number of epochs, as described herein. Upon execution of an epoch by model 208, component 208 updates one or more enhancement token values and feeds back the updated enhancement token value to component 204, which constructs an updated version of paired-training input 206 for the next epoch, and so on, until the specified number of epochs are exhausted. When the specified number of epochs are exhausted, application 202 produces, or the operation of application 202 results in, enhancement vector 222, as described herein.

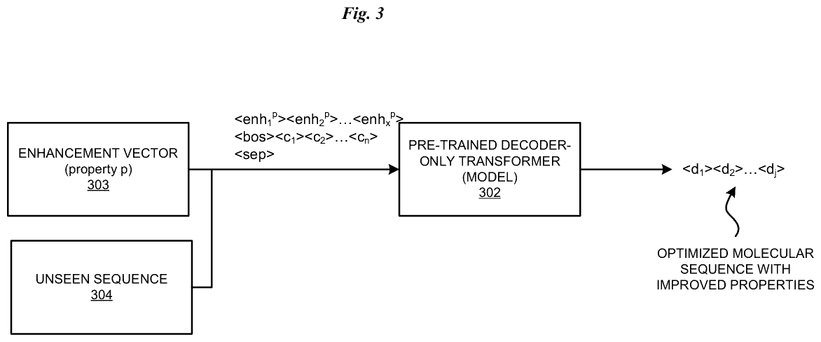

With reference to FIG. 3, this figure depicts a block diagram of an optimization mode operation using an enhancement vector in accordance with an illustrative embodiment. Model 302 is an example of pre-trained decoder only transformer, such as model 208 in FIG. 2.

Assume that property p is to be enhanced in an unseen initial molecule c. Further assume that enhancement vector 222 in FIG. 2 corresponds to property p and takes the form of <enh₁^{p}><enh₂^{p}><enhₓ^{p}>. This enhancement vector is represented as enhancement vector 303.

An unseen sequence 304 is constructed for molecule c, e.g., <c₁><c₂> . . . <cₙ>, as described herein, to represent an initial molecule. The enhancement vector 303 and unseen sequence 304 are combined to form the input to model 302 as shown, e.g., <enh₁^{p}><enh₂^{p}><enhₓ^{p}><bos><c₁><c₂> . . . <cₙ><sep>. Model 302 outputs optimized molecular sequence 306, which includes improved property p.

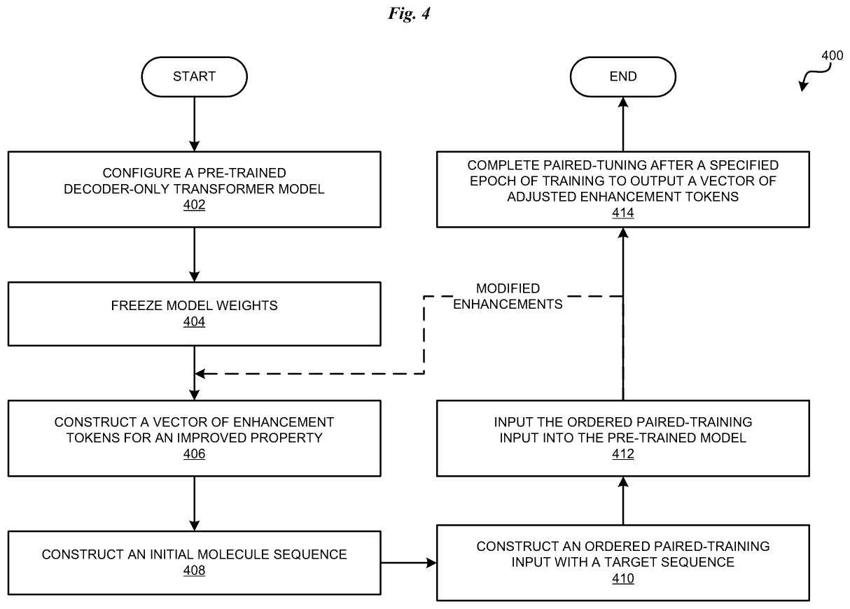

With reference to FIG. 4, this figure depicts a flowchart of an example process for paired tuning of generative models in accordance with an illustrative embodiment. Process 400 can be implemented in application 202 in FIG. 2.

The process configures a pre-trained decoder-only generative model (block 402). In one embodiment, the process pre-trains a decoder-only generative model at block 402. The process freezes the pre-trained weights int the model (block 404). The process constructs a vector of enhancement tokens for an improved property of an initial molecule (block 406). The process constructs an initial molecule sequence (block 408). The process constructs an ordered paired training input with a target molecule sequence (block 410).

The process inputs the ordered paired training input into the pre-trained model (block 412). Until a set epoch of training has elapsed, the process returns modified enhancement weights to block 406 for the next iteration of training prompt construction. Upon the exhaustion of the training epoch, the process completes the paired-tuning of the pre-trained decoder-only generative model to form an enhancement vector (block 414). The process ends thereafter.

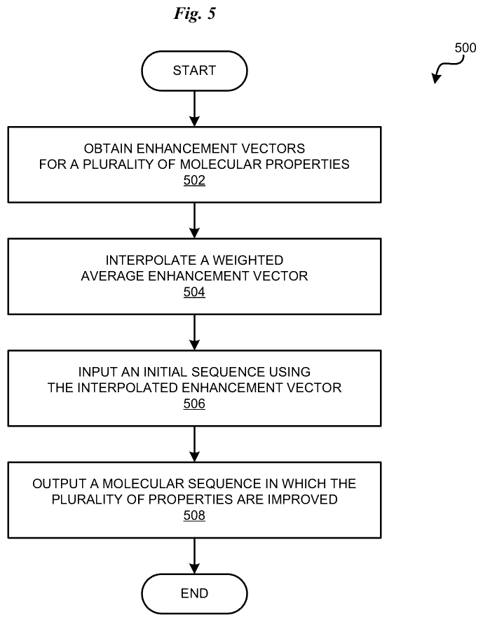

With reference to FIG. 5, this figure depicts a flowchart of an example process for generating molecular sequences with one or more improved properties in accordance with an illustrative embodiment. Process 500 can be implemented using improved model 222 in FIG. 2, such as in an application or system operating in conjunction with the improved model and configured to construct an input sequence in the manner of an embodiment.

The process obtains a set of enhancement token vectors corresponding to a set of properties that are to be enhanced in a molecular sequence (block 502). The process interpolates from the set of enhancement vectors, a single combined enhancement vector representative of the entire set of properties (block 504). While the interpolation process is described herein using a weighted average method of interpolation, from this disclosure, those of ordinary skill in the art will be able to conceive many other ways of interpolating a singular combined enhancement vector from a set of enhancement vectors. Such other methods of interpolation are contemplated within the scope of the illustrative embodiments.

The process inputs an initial molecular sequence using the interpolated enhancement vector (block 506). The process outputs a new molecular sequence in which each of the properties from the set of properties has been enhanced or improved, as described herein (block 508). The process ends thereafter.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
configuring a set of enhancement tokens to correspond to a property p;
constructing a training input to a pre-trained decoder-only generative model (model), the training input comprising the set of enhancement tokens, a set of first molecular description tokens representing an initial molecule, and a set of second molecular description tokens representing a target molecule, wherein property p in the target molecule is better relative to property p in the initial molecule;
executing the model with the training input; and
generating from the model, responsive to the executing, a vector of adjusted enhancement tokens (enhancement vector), the enhancement vector corresponding to an improvement in property p.

2. The computer-implemented method of claim 1, further comprising:
revising, as a part of the executing, during a first iteration of execution, an enhancement token in the set of enhancement tokens, the revising forming a second set of enhancement tokens;
constructing a second training input using the second set of enhancement tokens; and
executing the model in a second iteration of execution with the second training input.

3. The computer-implemented method of claim 1, further comprising:
forming, at an inference time, a plurality of enhancement vectors corresponding to a plurality of properties;
interpolating, from the plurality of enhancement vectors, an interpolated enhancement vector, wherein the interpolated enhancement vector corresponds to the plurality of properties;
constructing a new input to a pre-trained decoder-only generative model configured for molecule optimization (optimization model), the new input comprising the interpolated enhancement vector and a set of new molecular description tokens, the set of new molecular description tokens corresponding to a new molecule;
executing the optimization model with the new input;
outputting, responsive to the interpolated enhancement vector, from the optimization model, an improved new molecular sequence, wherein the improved new molecular sequence comprises an improvement in a first property in the plurality of properties in a new molecule corresponding to the new molecular sequence.

4. The computer-implemented method of claim 3, wherein the improved new molecular sequence further comprises an improvement in a second property in the plurality of properties in the new molecule corresponding to the new molecular sequence.

5. The computer-implemented method of claim 3, wherein the model is the optimization model.

6. The computer-implemented method of claim 3, wherein the model is distinct from the optimization model.

7. The computer-implemented method of claim 1, further comprising:
stopping the executing after a preset number of iterations, wherein an iteration of execution modifies at least one enhancement token in the set of enhancement tokens.

8. The computer-implemented method of claim 1, further comprising:
constructing a second training input comprising a second set of enhancement tokens, the set of first molecular description tokens representing the initial molecule, and the set of second molecular description tokens representing the target molecule, wherein property q in the target molecule is better relative to property q in the initial molecule;
executing the model with the second training input; and
generating from the model a second vector of adjusted enhancement tokens (second enhancement vector), the enhancement vector corresponding to an improvement in property q.

9. The computer-implemented method of claim 1, wherein property p comprises a first aspect and a second aspect, the improvement in property p is an improvement in the first aspect of property p, and wherein the enhancement vector corresponds to the improvement in the first aspect of property p, further comprising:
constructing a second training input comprising a second set of enhancement tokens, the set of first molecular description tokens representing the initial molecule, and the set of second molecular description tokens representing the target molecule, wherein the second aspect of property p in the target molecule is better relative to the second aspect of property p in the initial molecule;
executing the model with the second training input; and
generating from the model a second vector of adjusted enhancement tokens (second enhancement vector), the second enhancement vector corresponding to an improvement in the second aspect of property p.

10. The computer-implemented method of claim 1, further comprising:
pre-training a decoder-only generative model with training data; and freezing, subsequent to the pre-training, the set of pre-training weights in the decoder-only generative model to form the pre-trained decoder-only generative model.

11. A computer program product comprising:
One or more computer readable storage media; and
program instructions stored on the one or more storage media and configured to perform operations comprising:
configuring a set of enhancement tokens to correspond to a property p;
constructing a training input to a pre-trained decoder-only generative model (model), the training input comprising the set of enhancement tokens, a set of first molecular description tokens representing an initial molecule, and a set of second molecular description tokens representing a target molecule, wherein property p in the target molecule is better relative to property p in the initial molecule;
executing the model with the training input; and
generating from the model, responsive to the executing, a vector of adjusted enhancement tokens (enhancement vector), the enhancement vector corresponding to an improvement in property p.

12. The computer program product of claim 11, further comprising:
revising, as a part of the executing, during a first iteration of execution, an enhancement token in the set of enhancement tokens, the revising forming a second set of enhancement tokens;
constructing a second training input using the second set of enhancement tokens; and
executing the model in a second iteration of execution with the second training input.

13. The computer program product of claim 11, further comprising:
forming a plurality of enhancement vectors corresponding to a plurality of properties;
interpolating, from the plurality of enhancement vectors, an interpolated enhancement vector, wherein the interpolated enhancement vector corresponds to the plurality of properties;
constructing a new input to a pre-trained decoder-only generative model configured for molecule optimization (optimization model), the new input comprising the interpolated enhancement vector and a set of new molecular description tokens, the set of new molecular description tokens corresponding to a new molecule;
executing the optimization model with the new input;
outputting, responsive to the interpolated enhancement vector, from the optimization model, an improved new molecular sequence, wherein the improved new molecular sequence comprises an improvement in a first property in the plurality of properties in a new molecule corresponding to the new molecular sequence.

14. The computer program product of claim 13, wherein the improved new molecular sequence further comprises an improvement in a second property in the plurality of properties in the new molecule corresponding to the new molecular sequence.

15. The computer program product of claim 13, wherein the model is the optimization model.

16. The computer program product of claim 13, wherein the model is distinct from the optimization model.

17. The computer program product of claim 11, further comprising:
stopping the executing after a preset number of iterations, wherein an iteration of execution modifies at least one enhancement token in the set of enhancement tokens.

18. The computer program product of claim 11, wherein the stored program instructions are stored in a computer readable storage device in a data processing system, and wherein the stored program instructions are transferred over a network from a remote data processing system.

19. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
configuring a set of enhancement tokens to correspond to a property p;
constructing a training input to a pre-trained decoder-only generative model (model), the training input comprising the set of enhancement tokens, a set of first molecular description tokens representing an initial molecule, and a set of second molecular description tokens representing a target molecule, wherein property p in the target molecule is better relative to property p in the initial molecule;
executing the model with the training input; and
generating from the model, responsive to the executing, a vector of adjusted enhancement tokens (enhancement vector), the enhancement vector corresponding to an improvement in property p.
